(19) United States
(12) Patent Application Publication
(10) Pub. No.: US 2015/0324248 A1
(43) Pub. Date: Nov. 12, 2015

(54) INFORMATION PROCESSING DEVICE, CONTROL METHOD AND RECORDING MEDIUM FOR RECORDING CONTROL PROGRAM

(71) Applicant: FUJITSU LIMITED, Kawasaki-shi (JP)

(72) Inventors: Toshihiro TOMOZAKI, Sagamihara (JP); Terumasa Haneda, Machida (JP); Yoko Kawano, Yokohama (JP)

(73) Assignee: Fujitsu Limited, Kawasaki-shi (JP)

(21) Appl. No.: 14/644,293

(22) Filed: Mar. 11, 2015

(30) Foreign Application Priority Data
May 8, 2014 (JP) 2014-096788

(51) Int. Cl. G06F 11/10

(52) U.S. Cl. CPC G06F 11/1004; G06F 11/1076

(57) ABSTRACT

An information processing device includes: a processor; a first storage device configured to hold data that is read and written by the processor; and a controller configured to control data transfer between the processor and the first storage device, wherein the controller: reads out first data from the first storage device through a path without a data protection function; generates error check information for checking an error of the first data; writes the error check information as first error check information in a storage area bypassing the path; writes the error check information as second error check information in the first storage device through the path; compares the first error check information and the second error check information to each other; and determines, when the first error check information and the second error check information do not match each other, that an error has occurred in the path.

### CROSS-REFERENCE TO RELATED APPLICATION

This application is based upon and claims the benefit of priority of the prior Japanese Patent Application No. 2014-096788, filed on May 8, 2014, the entire contents of which are incorporated herein by reference.

### FIELD

The embodiments discussed herein are related to an information processing unit, a control method, and a recording medium for recording a control program.

### BACKGROUND

In an information processing unit, such as a control module (CM), and the like, provided in a storage device, when a power failure, or the like, occurs, data in a cache memory under a central processing unit (CPU) is saved in a nonvolatile memory using power from an at-power-failure feeding unit. In starting the information processing unit, the data saved (backed up) in the nonvolatile memory is returned to the cache memory, and processing of the information processing unit is re-started. In the following description, a situation, including a blackout, where power supply to the information processing unit is interrupted, is generally referred to as a “power failure”.

Related art is disclosed in Japanese Laid-open Patent Publication No. 2008-158591, Japanese Laid-open Patent Publication No. 2007-122476, or Japanese Laid-open Patent Publication No. 2006-065394.

### SUMMARY

According to an aspect of the embodiments, an information processing device includes: a processor; a first storage device configured to hold data that is read and written by the processor; and a controller configured to control data transfer between the processor and the first storage device, wherein the controller: reads out first data from the first storage device through a path without a data protection function; generates error check information for checking an error of the first data; writes the error check information as first error check information in a storage area bypassing the path; writes the error check information as second error check information in the first storage device through the path; compares the first error check information and the second error check information to each other; and determines, when the first error check information and the second error check information do not match each other, that an error has occurred in the path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example information processing unit;

FIGS. 2A to 2C are diagrams illustrating example cache memories;

FIG. 3 is a diagram illustrating example power failure processing performed when a power failure occurs;

FIG. 4 is a diagram illustrating an example information processing unit;

FIG. 5 is a diagram illustrating an example information processing unit;

FIG. 6 is a diagram illustrating an example information processing unit;

FIG. 7 is a diagram illustrating an example information processing unit; and

FIG. 8 is a diagram illustrating example power failure processing.

### DESCRIPTION OF EMBODIMENTS

As a memory of a backup destination of data of a cache memory, a solid state drive (SSD) that is compliant with serial advanced technology attachment (SATA) (SATA-SSD) is used. In SATA-SSD, before power is shut off, power off (P-OFF) sequence (SEQ) is executed by executing a Standby command, a Standby Immediate command, a Sleep command, or a like command. When power supply is interrupted without a power off sequence being executed, unexpected power off occurs and SATA-SSD might be damaged. The Standby command is a command to make SATA-SSD enter to a standby mode. The Standby Immediate command is a command to make SATA-SSD immediately enter to a standby mode. The Sleep command is a command to make SATA-SSD enter to a sleep mode. SATA-SSD will be hereinafter referred to as “SSD” for the sake of convenience.

In order to protect data, when data of a cache memory is saved in SSD, a cyclic redundancy check (CRC) code is generated for a data block having a certain size, and the CRC code is saved with the data in SSD. In data of the cache memory which is to be backed up in SSD, an area where data is protected by a hardware or a firmware and an area where data protection is not provided at all exist.

A function of backing up data of the cache memory in SSD may be mounted as a field-programmable gate array (FPGA). A hardware component provided from a vendor of FPGA might not have a data protection mechanism. When a hardware component which does not have such a data protection function breaks down, data might be damaged.

When a component which does not have a data protection function is used, data in an area where data protection for a cache memory is not provided might be damaged due to a hardware failure or the like, and the damaged data might be backed up in SSD. After recovery of the power supply (power recovery) of the information processing system, when the damaged data is restored in the cache memory from SSD, a system down of the information processing system might occur.

Therefore, some kind of data protection function may be provided for data for which data protection by a hardware or a firmware is not provided. If a data protection function is newly provided in the information processing system, the existing hardware or firmware is changed, and thus, costs might be increased. In this case, data protection may be provided using the existing configuration of the information processing system.

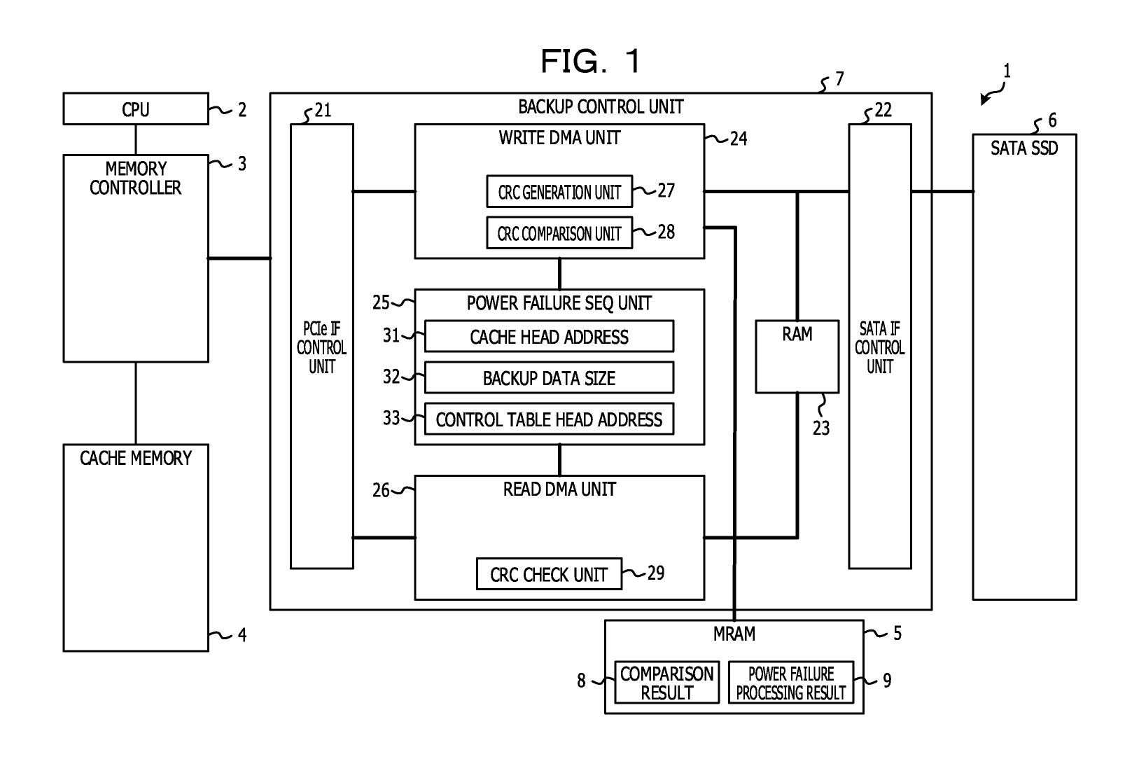

FIG. 1 is a diagram illustrating an example information processing unit. FIG. 1 illustrates a hardware configuration of an information processing unit 1. The information processing unit 1 (a computer) may be, for example, a storage control unit (a control module or CM), or the like, provided in a storage device. The information processing unit 1 may include a CPU 2, a memory controller 3, a cache memory 4, a magnetoresistive random access memory (MRAM) 5, SATA-SSD 6, and a backup control unit 7 (a control unit).

CPU 2 is a processing unit that performs various controls and calculations, and executes an operating system (OS) or a program stored in a memory or the like to thereby execute various functions. CPU 2 may be, for example, known CPU. The memory controller 3 controls transfer of data between CPU 2 and the cache memory 4, between CPU 2 and the backup control unit 7, and between the cache memory 4 and the backup control unit 7.

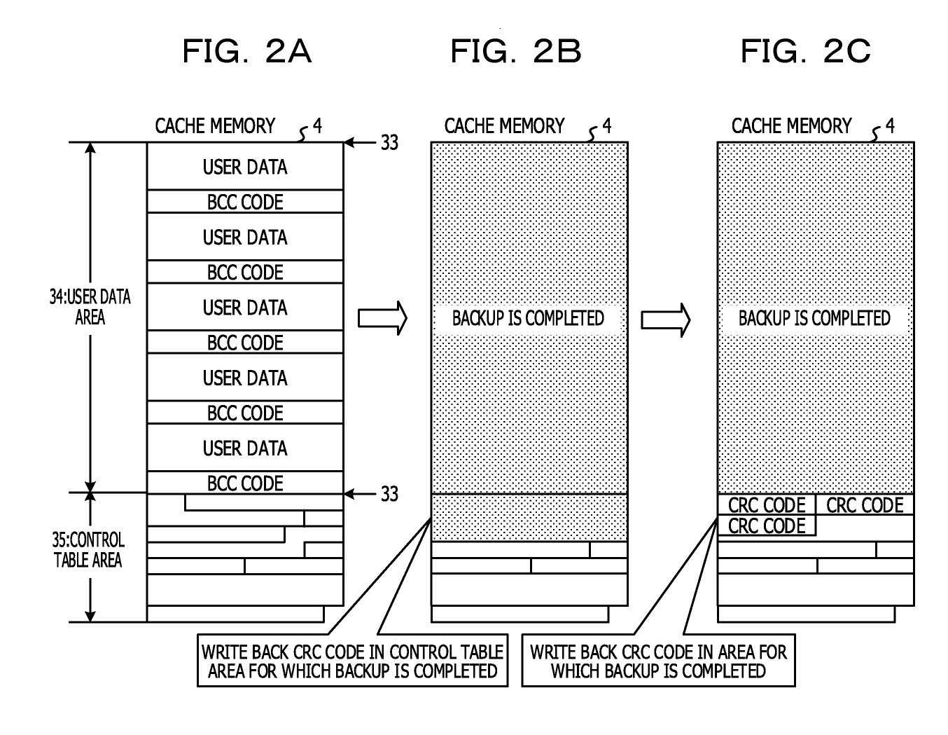

The cache memory 4 may be a memory that is capable of high speed access for temporarily storing data that is read and written from and to CPU 2. FIGS. 2A to 2C are diagrams illustrating example cache memories. FIG. 2A illustrates a data placement in the cache memory 4. FIG. 2B illustrates a state of the cache memory 4 being backed up at power failure. FIG. 2C illustrates write of the CRC code to the cache memory 4 at power failure.

As illustrated in FIG. 2A, in a normal state, in the cache memory 4, a user data area 34 where user data is written and a control table area 35 where a control table that is managed by each firmware component of the information processing unit 1 is written exist. In the user data area 34, a block check code (BCC) for protecting data of a block is generated for each block of the user data, which has a certain size. BCC may be generated by a firmware of the memory controller 3, the backup control unit 7, or the like, and may be written immediately after the user data.

For data of the user data area 34, BCC is generated, and the data is protected by BCC. For example, even if, when the user data of the user data area 34 is read out via the PCIe IF control unit 21, data is damaged due to a hardware failure of a PCIe IF control unit 21, or the like, data damage is detected from BCC. The generation of BCC may be performed using a known BCC generation method.

In the control table area 35, a control table used by various types of hardware and firmware of the information processing unit 1 is stored. Data of the control table area 35 is not provided with BCC, and therefore, data protection might not be provided. Thus, in the case where the data of the control table area 35 is read out via the PCIe IF control unit 21, even when data is damaged due to a hardware failure of the PCIe IF control unit 21, or the like, damage of data might not be detected.

Unlike the data of the user data area 34, the data of the control table area 35 has a variable data length, not a fixed block length, and therefore, BCC management is difficult. Also, the data of the control table area 35 is often updated, and therefore, if BCC is generated each time data is updated, the performance of the information processing unit 1 might be reduced. For this reason, the data of the control table area 35 might not be provided with BCC.

At power failure of the information processing unit 1, after data backup of the cache memory 4 illustrated in FIG. 2B, as illustrated in FIG. 2C, a CRC code used for error detection in the control table area 35 is written in the control table area 35. As the cache memory 4, for example, a static random access memory (SRAM) may be used.

MRAM 5 may be a nonvolatile memory using magnetism, and is used for holding various types of data for management, which are held even after the power of the information processing unit 1 is shut off. MRAM 5 may be used for storing a comparison result 8 and a power failure processing result 9. The comparison result 8 indicates a result of CRC comparison processing performed by a CRC comparison unit 28. For example, for the comparison result 8, when an error occurs during power failure processing, a value “0” may be set, and when power failure processing is successfully performed, a value of “1” may be set. Causes for an error during power failure processing may include, for example, a hardware failure of the PCIe IF control unit 21 that controls a PCI Express (PCIe) interface (IF), and the like.

The power failure processing result 9 indicates a result of a power off sequence of the information processing unit 1. For example, for the power failure processing result 9, when an error occurs in a power off sequence, a value “0” is set, and when a power off sequence is successfully performed, a value of “1” is set. Causes for an error during power failure processing may include, for example, a hardware failure of a component of the information processing unit 1, or the like.

SATA-SSD 6 may be a nonvolatile memory in which data stored in the cache memory 4 is backed up when a power failure, or the like, occurs. As SATA-SSD 6, known SATA-SSD may be used. For the sake of simplification, SATA-SSD 6 may be referred to as “SSD 6”. In the following description, a situation, including a blackout, where power supply to the information processing unit 1 is interrupted is generally referred to as a “power failure”.

The backup control unit 7 may be FPGA that performs power failure processing at power failure. For example, when the backup control unit 7 receives power supply of DC power from an at-power-failure feeding unit, the backup control unit 7 backs up data stored in the cache memory 4 in SSD 6 and executes a power off sequence of SSD 6. In the information processing unit 1, the memory controller 3 and the backup control unit 7 may be coupled to each other, for example, via a four-lane PCIe link 11. User data that is to be backed up in SSD 6 from the cache memory 4 is transmitted from the cache memory 4 to the backup control unit 7 through the PCIe link 11 via the memory controller 3.

The backup control unit 7 and SSD 6 may be coupled to each other through a SATA link 12. User data that is to be backed up in SSD 6 from the cache memory 4 is transmitted from the backup control unit 7 to SSD 6 through the SATA link 12. The backup control unit 7 includes the PCIe IF control unit (path) 21, a SATA IF control unit 22, a saving random access memory (RAM) (a temporary storage area) 23, a write DMA unit (which will be also referred to as a “write DMA) 24, a power failure sequence (SEQ) unit 25, and a read DMA unit (which will be also referred to as a “read DMA”) 26.

The PCIe IF control unit 21 may be a processing unit that controls communication between the memory controller 3 and the backup control unit 7 through the PCIe link 11. The PCIe IF control unit 21 may be implemented, for example, as a circuit. The SATA IF control unit 22 may be a processing unit that controls communication between the backup control unit 7 and SSD 6 through the SATA link 12. The SATA IF control unit 22 may be implemented, for example, as a circuit.

The saving RAM 23 may be a storage area that stores a CRC code generated by a CRC generation unit 27 from data read from the cache memory 4. For example, as the saving RAM 23, unused extra RAM provided in FPGA of the backup control unit 7 may be used. Thus, because extra RAM is used, change or addition for the hardware of the backup control unit 7 might not be performed for implementing the function of the information processing unit 1.

When a power failure occurs in the information processing unit 1, the power failure sequence unit 25 executes a power failure sequence. The power failure sequence unit 25 may be implemented, for example, as a circuit. The power failure sequence unit 25 starts the write DMA unit 24 to cause the write DMA unit 24 to back up data of the cache memory 4 in SSD 6. Thereafter, the power failure sequence unit 25 starts the read DMA unit 26 to cause the read DMA unit 26 to write a CRC code to the control table area 35 of the cache memory 4.

The power failure sequence unit 25 includes registers of a cache head address 31, a backup data size 32, and a control table head address 33. The cache head address 31 stores a value indicating the head address of the cache memory 4 which is to be backed up in SSD 6 at power failure. The backup data size 32 stores a value indicating the data size of the cache memory 4 which is to be backed up in SSD 6 at power failure.

The control table head address 33 stores a value indicating the head address of the control table area 35 in the cache memory 4. Each of the values of the cache head address 31, the backup data size 32, and the control table head address 33 may be set, for example, by CPU 2 during a power failure operation. The write DMA unit 24 may be a processing unit that performs write of data between the memory controller 3 and SSD 6 using a direct memory access. For example, the write DMA unit 24 writes data which is to be backed up in SSD 6 from the cache memory 4 in SSD 6 from the cache memory 4 via the memory controller 3.

The write DMA unit 24 writes data read from the cache memory 4 to SSD 6. “Write” of the write DMA unit 24 is write to SSD 6, and a read operation is performed on the cache memory 4. The write DMA unit 24 includes the CRC generation unit 27 which may correspond to a generation unit or a first write unit and the CRC comparison unit 28 which may correspond to a determination unit.

The CRC generation unit 27 generates a CRC code, which may correspond to error check information, from backup target data read from the cache memory 4 via the PCIe IF control unit 21 during power failure processing, and writes (backs up) the CRC code with the read-out data in SSD 6. For example, in data transfer performed in the information processing unit 1, when the data amount of transfer is large, data that is to be transferred may be divided into a plurality of blocks, and data transfer may be divided and performed in a plurality of times in units of divided blocks. Thus, the write DMA unit 24 reads data that is to be backed up a plurality of times separately in order, starting with the head address of the cache memory 4. The CRC generation unit 27 generates a CRC code for each block of data read out from the cache memory 4. The CRC generation unit 27 may perform the generation of a CRC code using a well-known CRC generation algorithm. When the data read out from the cache memory 4 is data stored in the control table area 35, the generated CRC is stored in the saving RAM 23 for each block of the cache memory 4.

The CRC comparison unit 28 compares the CRC code written in the control table area 35 of the cache memory 4 by a CRC check unit 29 and the corresponding CRC code saved in the saving RAM 23 by the CRC generation unit 27 to each other. The CRC comparison unit 28 may set, as the comparison result 8 of MRAM 5, for example, “1” when both of the CRC codes match each other, and “0” when the both of the CRC codes do not match each other.

A cause for mismatch of the CRC code of the control table area 35 of the cache memory 4 and the CRC code of the saving RAM 23 includes a hardware failure of the PCIe IF control unit 21 which does not have a data protection mechanism. The CRC code written in the control table area 35 of the cache memory 4 by the CRC check unit 29 is read and written via the PCIe IF control unit 21, and therefore, when a hardware failure occurs in the PCIe IF control unit 21, data might be damaged. The CRC code written (saved) in the saving RAM 23 by the CRC generation unit 27 is read and written without passing via the PCIe IF control unit 21, and therefore, might not be influenced by a hardware failure that has occurred in the PCIe IF control unit 21.

The write DMA unit 24 may be implemented, for example, as a circuit. The read DMA unit 26 may be a processing unit that performs read of data between the memory controller 3 and SSD 6 using a direct memory access. When recovery of the power supply (which will be referred to as “power recovery”) of the information processing unit 1 after a power failure of the information processing unit 1, the read DMA unit 26 writes back data backed up in SSD 6 in the cache memory 4. “Read” of the read DMA unit 26 indicates write to SSD 6, and a read operation is not performed on the cache memory 4.

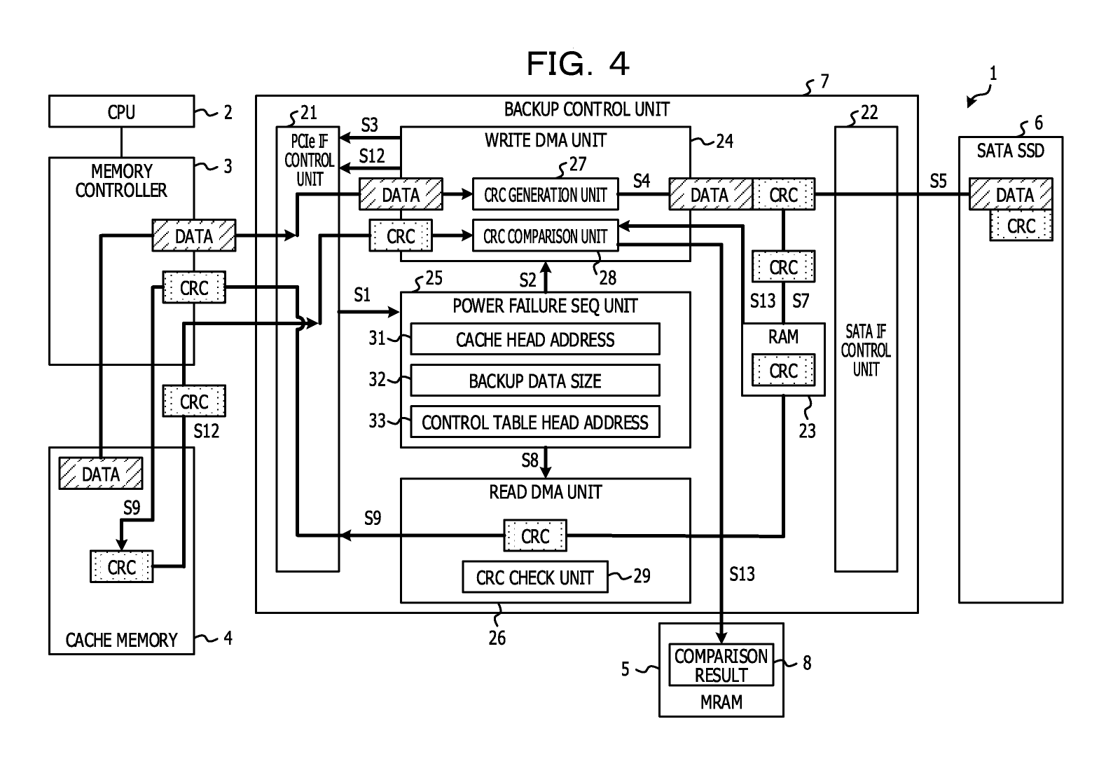

The read DMA unit 26 may be used, in power failure processing of the information processing unit 1, for performing determination on whether or not there is a hardware error of the PCIe IF control unit 21. The read DMA unit 26 includes the CRC check unit 29. As illustrated in FIG. 2C, the CRC check unit 29 writes, in order, CRC codes (see, for example, FIG. 4) stored in the saving RAM 23 by the CRC generation unit 27 in from the head of parts of the control table area 35 of the cache memory 4, for which backup to SSD 6 has been already finished. The CRC code written by the CRC check unit 29 after backup of the cache memory 4 is completed is read out from the cache memory 4 by the CRC comparison unit 28 of the write DMA unit 24. The CRC comparison unit 28 compares the read-out CRC code to the CRC code that has been transferred again via the PCIe IF control unit 21 which does not have a data protection mechanism and saved. The CRC comparison unit 28 detects whether or not there is a data error due to a hardware failure of the PCIe IF control unit 21, or the like.

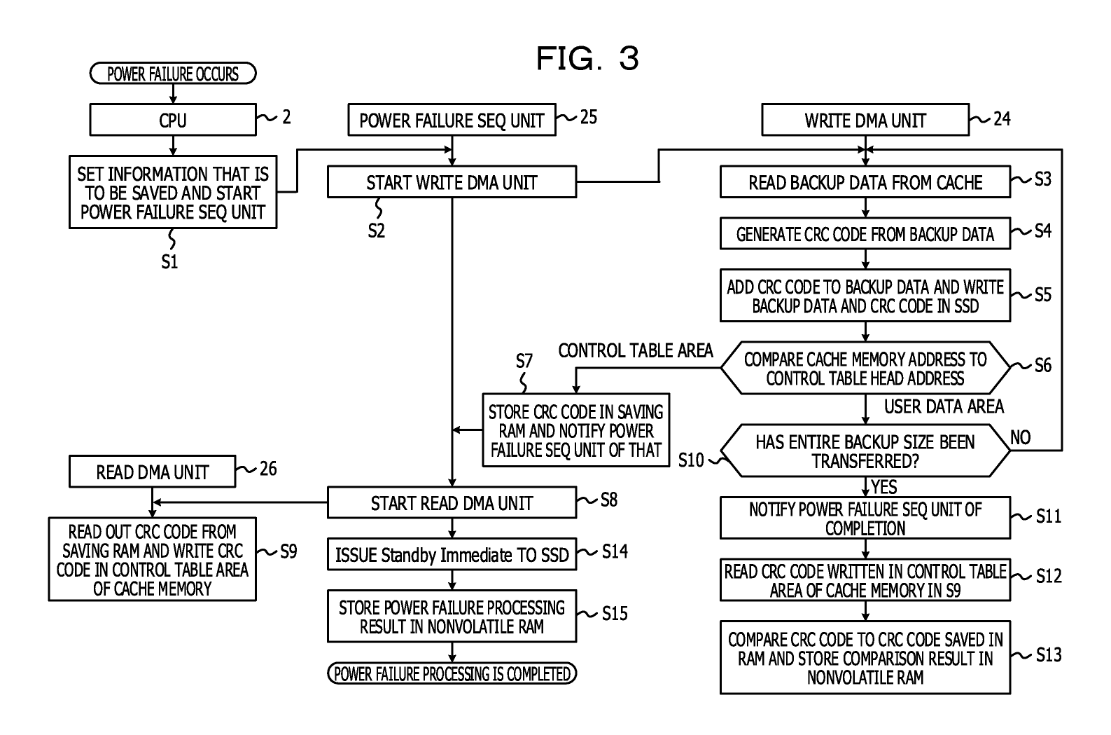

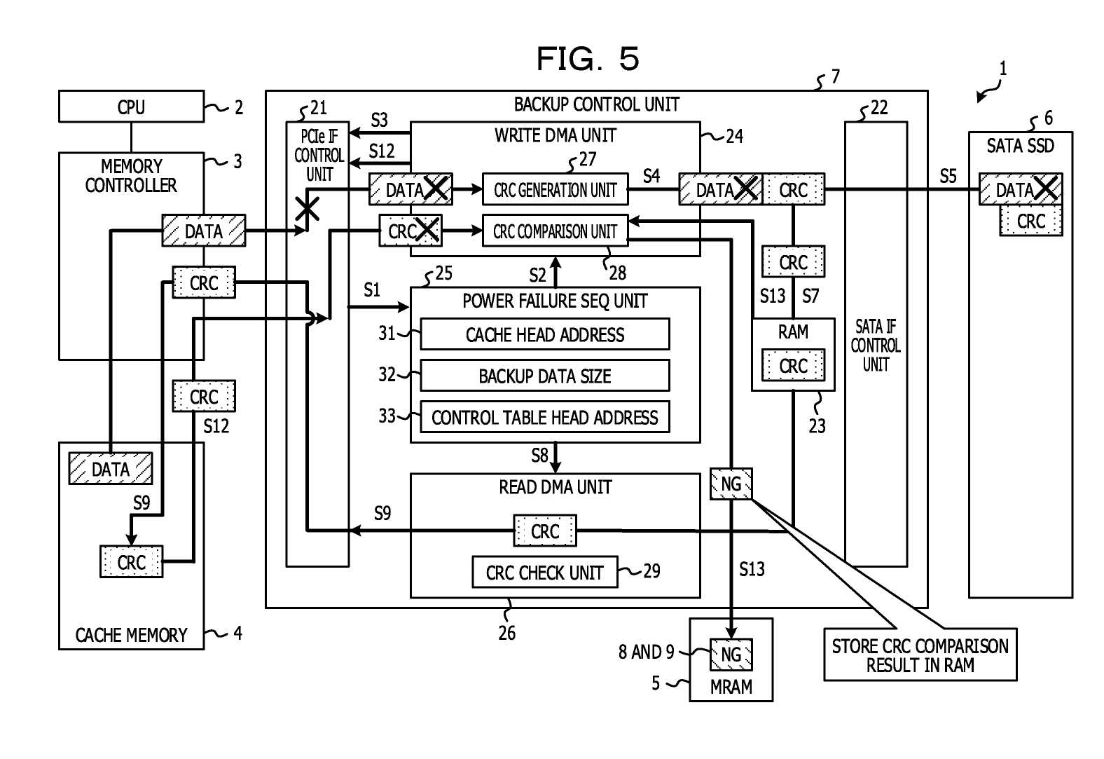

The read DMA unit 26 may be implemented, for example, as a circuit. FIG. 3 is a diagram illustrating example power failure processing performed when a power failure occurs. Power failure processing illustrated in FIG. 3 may be executed by the information processing unit 1 illustrated in FIG. 1. Each of FIG. 4 and FIG. 5 is a diagram illustrating an example information processing unit. FIG. 4 illustrates an information processing unit 1 that executes power failure processing. FIG. 5 illustrates an information processing unit 1 when data damage is generated in power failure processing. In FIG. 4 and FIG. 5, operation numbers illustrated with arrows correspond to operation numbers illustrated in FIG. 3.

In Operation S1, a power failure occurs in the information processing unit 1. Then, CPU 2 stores each of the head address of the cache memory 4 data of which is to be saved in SSD 6, the entire data size of backup targets, and the head address of the control table area 35 in the corresponding one of the registers of the head address 31, the backup data size 32, and the control table head address 33 of the power failure sequence unit 25. After CPU 2 starts the power failure sequence unit 25, CPU 2 enters a sleep mode in order to reduce the consumption of a battery of the at-power-failure feeding unit.

In Operation S2, the power failure sequence unit 25 starts the write DMA unit 24. In Operation S3, based on information stored in each register of the power failure sequence unit 25 by CPU 2 in Operation S1, the write DMA unit 24 reads target data that is to be backed up in SSD 6 from the cache memory 4 through the PCIe IF control unit 21. For example, in data transfer performed in the information processing unit 1, when the data amount of transfer is large, data that is to be transferred may be divided into a plurality of blocks, and data transfer may be divided and performed in a plurality of times in units of divided blocks. The write DMA unit 24 may read data that is to be backed up in order, starting with the head address of the cache memory 4, by dividing and performing the read in a plurality of times.

In Operation S4, the CRC generation unit 27 of the write DMA unit 24 generates a CRC code from the backup target data read from the cache memory 4 in Operation S3. In Operation S5, the write DMA unit 24 adds the CRC code generated in Operation S4 to the backup data read in Operation S3, and writes the backup data and the CRC code in SSD 6 via the SATA IF control unit 22.

In Operation S6, the CRC comparison unit 28 of the write DMA unit 24 compares the address of the cache memory 4 read in Operation S3 and a value stored in the control table head address 33 of the power failure sequence unit 25 to each other, and determines whether the data is a control table or user data. If the data is data read out from the control table area 35 (see the “control table area” route in Operation S6), in Operation S7, the write DMA unit 24 stores the CRC code generated by the CRC generation unit 27 in the saving RAM 23, and notifies the power failure sequence unit 25 of that.

The power failure sequence unit 25 that has received a notification from the write DMA unit 24 in Operation S7 starts the read DMA unit 26 in Operation S8. In Operation S9, the read DMA unit 26 reads out the CRC code saved in the saving RAM 23 by the write DMA unit 24 in Operation S7 from the saving RAM 23, and writes the CRC code to the head address of the control table area 35 of the cache memory 4 (see FIG. 2B).

If the data read out in Operation S5 is data read out from the user data area 34 (see the “user data area” route in Operation S6), in Operation S10, the write DMA unit 24 determines whether or not the data size of the entire data of backup targets has been all transferred. If the entire data of backup targets has not been transferred (see the NO route of Operation S10), the process returns to Operation S3, and the processing of Operations S3 to S10 is repeated for a next data block of the cache memory 4.

If the entire data of backup targets has been all transferred (see the YES route of Operation S10), in Operation S11, the write DMA unit 24 notifies the power failure sequence unit 25 of the completion of transfer of the entire data of backup targets. In Operation S12, the write DMA unit 24 reads out the CRC code written in the control table area 35 of the cache memory 4 in Operation S9 from the control table area 35 through the PCIe IF control unit 21.

In Operation S13, the CRC comparison unit 28 of the write DMA unit 24 compares the CRC code read out in Operation S12 to the CRC code saved in the saving RAM 23 by the write DMA unit 24 in Operation S7. For example, in FIG. 5, data read out from the cache memory 4 and backed up in SSD 6 is damaged due to a hardware failure of the PCIe IF control unit 21, or the like. In FIG. 5, damaged data is denoted by “x”. In this case, the CRC code read out from the cache memory 4 via the PCIe IF control unit 21 and the CRC code read out from the saving RAM 23 without passing via the PCIe IF control unit 21 do not match each other.

The CRC comparison unit 28 sets a comparison result to the comparison result 8 of MRAM 5. In FIG. 5, a single comparison may be performed. For example, when the CRC generation unit 27 reads the data of the control table area 35 of the cache memory 4 a plurality of times separately, the generation of a CRC code and write to the saving RAM 23 performed by the CRC generation unit 27, write to the cache memory 4 performed by the CRC check unit 29, and CRC comparison performed by the CRC comparison unit 28 may be executed a plurality of times. If a result of CRC comparison performed by the CRC comparison unit 28 is mismatch even once, a value indicating mismatch (NG) may be set to the comparison result 8 of MRAM 5.

In Operation S14 performed after Operation S8, the power failure sequence unit 25 issues Standby Immediate to SSD 6. Standby Immediate may be a well-known command. In Operation S15, the power failure sequence unit 25 sets a result of power failure processing performed in Operation S14 to the power failure processing result 9 of MRAM 5.

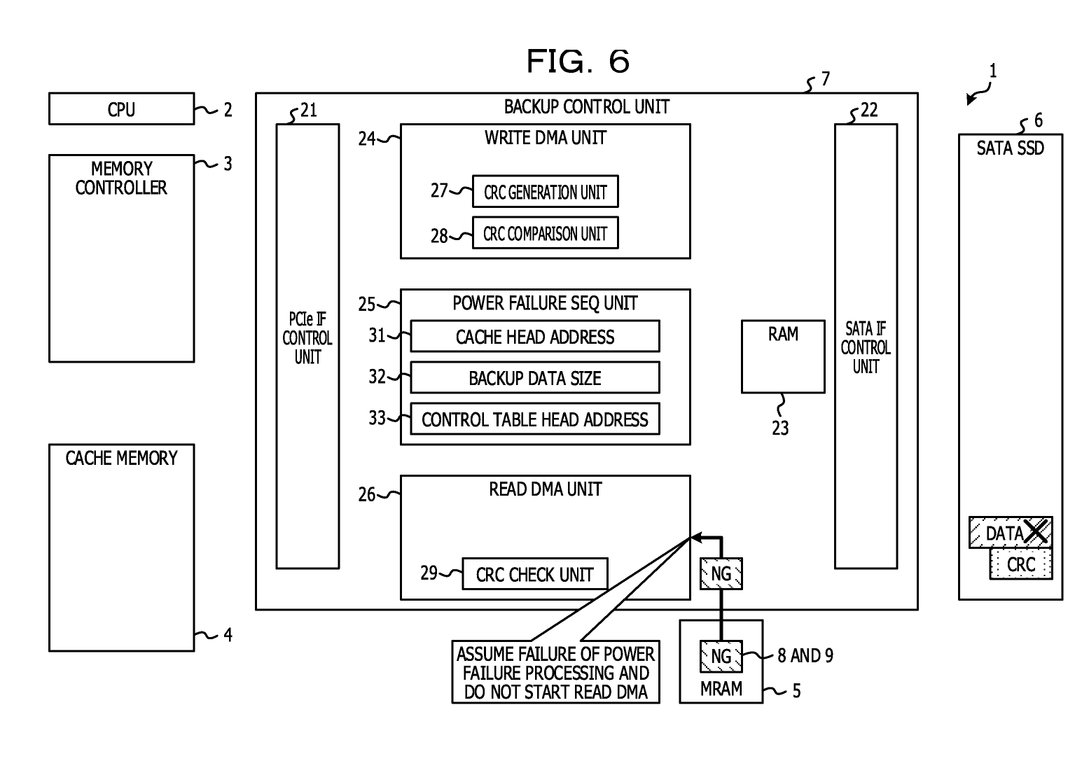

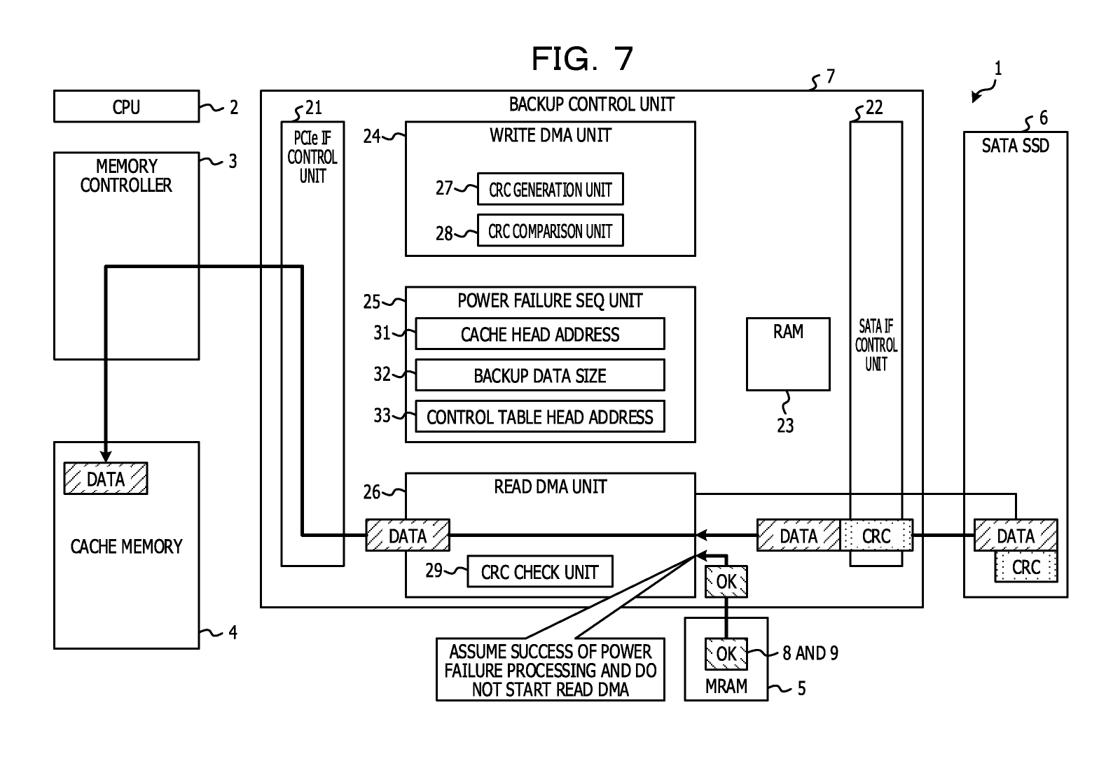

Each of FIG. 6 and FIG. 7 is a diagram illustrating an example information processing unit. FIG. 6 illustrates an information processing unit 1 that performs power recovery processing when power failure processing fails, and FIG. 7 illustrates an information processing unit 1 that performs power recovery processing when power failure processing is successfully performed. Upon recovery of the power source of the information processing unit 1, the value stored in MRAM 5 in Operation S15 is read out by the read DMA unit 26. Data baked up in SSD 6 based on the read-out value is written back in the cache memory 4.

As illustrated in FIG. 6, if a value which indicate a failure of power failure processing, for example, “0” (NG), is stored in the comparison result 8 or the power failure processing result 9 of MRAM 5, the read DMA unit 26 does not write back data backed up in SSD 6 in the cache memory 4. As illustrated in FIG. 7, if a value which indicates a success of power failure processing, for example, “1” (OK), is stored in the comparison result 8 or the power failure processing result 9 of MRAM 5, the read DMA unit 26 writes back data backed up in SSD 6 in the cache memory 4.

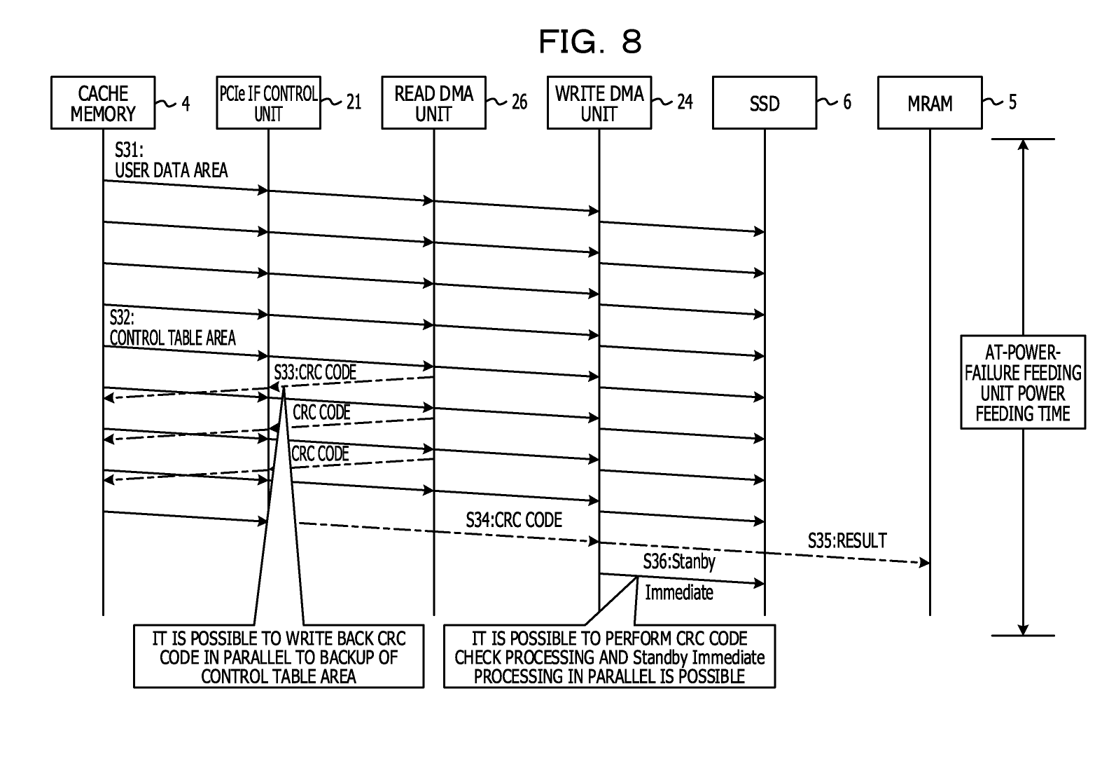

FIG. 8 is a diagram illustrating example power failure processing. The power failure processing illustrated in FIG. 8 may be executed by the information processing unit 1 illustrated in FIG. 1. When a power failure occurs in the information processing unit 1, in Operation S31, the write DMA unit 24 backs up data of the user data area 34 of the cache memory 4 a plurality of times separately in SSD 6. In FIG. 8, for example, five data transfers are performed.

In Operation S32, the write DMA unit 24 backs up data of the control table area 35 of the cache memory 4 a plurality of times separately in several times in SSD 6. In FIG. 8, four data transfers are performed. The CRC comparison unit 28 of the write DMA unit 24 generates a CRC code of each data of the control table area 35, and stores the generated CRC code in the saving RAM 23.

In Operation S33, the read DMA unit 26 reads out each CRC code saved in the saving RAM 23, and writes the read-out CRC code in the control table area 35 of the cache memory 4. PCI-Express is capable of bidirectional control, and therefore, Operation S33 may be performed in parallel to Operation S32. In Operation S34, the CRC comparison unit 28 of the write DMA unit 24 reads out the CRC code written in the cache memory 4 by the read DMA unit 26 in Operation S32.

In Operation S35, the CRC comparison unit 28 compares the read-out CRC code to the CRC code saved in the saving RAM 23 in Operation S34, and sets a comparison result to the comparison result 8 of MRAM 5. In Operation S36, the write DMA unit 24 issues a Standby Immediate command. At power failure of the information processing unit 1, the CRC generation unit 27 of the write DMA unit 24 reads out data of the cache memory 4, generates a CRC code of the read-out data, and backs up the read-out data and the CRC code in SSD 6. If the data read out from the cache memory 4 is data of the control table area 35, the generated CRC code is saved in the saving RAM 23.

The CRC check unit 29 of the read DMA unit 26 writes the CRC code saved in the saving RAM 23 in the cache memory 4. The CRC comparison unit 28 of the write DMA unit 24 compares the CRC code saved in the saving RAM 23 and the CRC code written in the cache memory 4 to each other and, if both of the codes do not match each other, the CRC comparison unit 28 determines that a hardware error, or the like, has occurred in the information processing unit 1.

Thus, for the data of the control table area 35 of the cache memory 4 which does not have BCC for data protection, the CRC comparison unit 28 in which error detection might be performed sets, if the CRC comparison unit 28 determines that an error has occurred, a value indicating CRC mismatch to the comparison result 8 of MRAM 5, and therefore, after power recovery of the information processing unit 1, restoration of data backed up in SSD 6 to the cache memory 4 might be reduced.

After power recovery, a system down of the information processing unit 1 or data corruption that is to be caused by restoration of the damaged data to the cache memory 4 might not be caused. The CRC check unit 29 of the read DMA unit 26 writes the CRC code saved in the saving RAM 23 in the control table area 35 of the cache memory 4. Thus, data protection might be provided without increasing the capacity of the existing cache memory 4.

PCI-Express is capable of bidirectional control, and therefore, write of a CRC code to the cache memory 4 performed by the CRC check unit 29 and backup processing on SSD 6 performed by the CRC generation unit 27 might be implemented in parallel. CRC code read and comparison processing performed by the CRC comparison unit 28 and Standby Immediate processing performed on SSD 6 might be implemented in parallel. Thus, additional processing might be performed within an existing power failure processing time without influencing the power failure processing performance.

The above-described function may be executed using RAM 23 and the read DMA unit 26 provided in the backup control unit 7. Thus, without adding a component, highly reliable power failure processing might be executed using the existing hardware configuration of the backup control unit 7, not causing a cost increase.

For example, data protection during data read and write that is to be performed when power off sequence processing at power failure of the information processing unit 1 is performed may be provided, and also data protection that is to be provided in some other case may be provided. For example, the above-described processing may be used for transferring data which does not have a data protection function.

The comparison result 8 and the power failure processing result 9 of MRAM 5 illustrated in FIG. 6 and FIG. 7 are compared to each other under an AND condition. For example, the comparison result 8 and the power failure processing result 9 are compared to each other in terms of whether a value indicating a failure of power failure processing is stored in both of the comparison result 8 and the power failure processing result 9 (FIG. 6) or whether or not a value indicating a success of power failure processing is stored in both of the comparison result 8 and the power failure processing result 9 (FIG. 7). For example, another comparison logic may be used for comparing the comparison result 8 and the power failure processing result 9 to each other.

The backup control unit 7 may be implemented as FPGA, and the PCIe IF control unit 21, the SATA IF control unit 22, the write DMA unit 24, the power failure sequence unit 25, and the read DMA unit 26 may be implemented as a circuit. For example, the backup control unit 7, the PCIe IF control unit 21, the SATA IF control unit 22, the write DMA unit 24, the power failure sequence unit 25, and the read DMA unit 26 may be implemented as software.

In that case, CPU 2 of the information processing unit 1 executes a control program, and thus, the backup control unit 7, the PCIe IF control unit 21, the SATA IF control unit 22, the write DMA unit 24, the power failure sequence unit 25, and the read DMA unit 26 function. The control program used for executing functions as the backup control unit 7, the PCIe IF control unit 21, the SATA IF control unit 22, the write DMA unit 24, the power failure sequence unit 25, and the read DMA unit 26 may be provided in a form recorded in a computer-readable recording medium, such as, a flexible disk, a CD (a CD-ROM, a CD-R, a CD-RW, or the like), a DVD (a DVD-ROM, a DVD-RAM, a DVD-R, a DVD+R, a DVD-RW, a DVD+RW, a HD DVD, or the like), a Blu-ray disc, a magnetic disk, an optical disk, a magnetooptical disk, and the like. A computer reads a program from the recording medium using a medium reader, transfers and stores the program to and in an internal storage device or an external storage device, and uses the program. For example, a program may be provided to a computer from a storage device (a recording medium), such as a magnetic disk, an optical disk, or a magnetooptical disk, in which the program is recorded, via a communication path.

In order to implement functions as the backup control unit 7, the PCIe IF control unit 21, the SATA IF control unit 22, the write DMA unit 24, the power failure sequence unit 25, and the read DMA unit 26, a program stored in an internal storage device, for example, a memory, or the like, is executed by a microprocessor, for example, a CPU, of a computer. In this case, the program recorded in the recording medium may be read and then executed by the computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a processor;
a first storage device configured to hold data that is read and written by the processor; and
a controller configured to control data transfer between the processor and the first storage device,
wherein the controller:
reads out first data from the first storage device through a path without a data protection function;
generates error check information for checking an error of the first data;
writes the error check information as first error check information in a storage area bypassing the path;
writes the error check information as second error check information in the first storage device through the path;
compares the first error check information and the second error check information to each other; and
determines, when the first error check information and the second error check information do not match each other, that an error has occurred in the path.

2. The information processing device according to claim 1,
wherein the controller writes the first data and the error check information in a second storage device that is different from the first storage device.

3. The information processing device according to claim 1,
wherein the first storage device has a first area for the first data in which data protection is not provided and a second area for second data in which data protection is provided, and
the controller writes the second error check information in the first area for the first data of the first area.

4. The information processing device according to claim 1,
wherein the controller performs the determination based on power from an auxiliary power source when power supply of a main power source is stopped.

5. The information processing device according to claim 4,
wherein, when the controller determines that the error has occurred in the path, the controller does not write back the first data in the first storage device from the second storage device after power recovery of the main power source.

6. The information processing device according to claim 1,
wherein, when the error occurs in power supply stop processing for the main power source, the controller does not write back the first data in the first storage device from the second storage device after power recovery of the main power source.

7. The information processing device according to claim 1,
wherein the path is a path using a PCI Express interface.

8. A control method comprising:
reading out first data from a first storage device through a path that does not have a data protection function;
generating error check information for checking an error of the first data;
writing the error check information as first error check information in a storage area without passing through the path;
writing the error check information as second error check information in the first storage device through the path;
comparing the first error check information and the second error check information to each other; and
determining, when the first error check information and the second error check information do not match each other, that an error has occurred in the path.

9. The control method according to claim 8,
wherein the first data and the error check information are written in a second storage device that is different from the first storage device.

10. The control method according to claim 8,
wherein the first storage device has a first area for the first data in which data protection is not provided and a second area for second data in which data protection is provided, and writes the second error check information in the first area for the first data of the first area.

11. The control method according to claim 8,
wherein the determining is performed based on power supply from an auxiliary power source when power supply of a main power source is stopped.

12. The control method according to claim 11,
wherein, when it is determined that the error has occurred in the path, write back of the data in the first storage device from the second storage device after power recovery of the main power source is not performed.

13. The control method according to claim 8,
wherein, when the error occurs in power supply stop processing for the main power source, write back of the first data in the first storage device from the second storage device after power recovery of the main power source is not performed.

14. The control method according to claim 8,
wherein the path is a path using a PCI Express interface.

15. A recording medium for recording a control program to be executed by a computer,
wherein, based on the control program, the computer:
reads out first data from a first storage device through a path that does not have a data protection function;
generates error check information for checking an error of the first data;
writes the error check information as first error check information in a storage area bypassing the path;
writes the error check information as second error check information in the first storage device through the path; and
compares the first error check information and the second error check information to each other; and
determines, when the first error check information and the second error check information do not match each other, that an error has occurred in the path.
